(19) United States
(12) Patent Application Publication
(10) Pub. No.: US 2010/0074219 A1
(43) Pub. Date: Mar. 25, 2010

(54) Methods and Apparatus for Reverse Link Timing Correction

(75) Inventors: Edward Harrison Teague, San Diego, CA (US); Dhananjay Ashok Gore, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/234,990

(22) Filed: Sep. 22, 2008

(51) Int. Cl. H04Q 7/00

(52) U.S. Cl. 370/331

(57) ABSTRACT

Methods and apparatus for reverse link timing correction in a wireless communication device. In particular, when a handoff of the device from a first sector currently serving the device to a second sector not currently serving the device is detected, a first function linking timing correction of a reverse link of the device to forward link timing corrections is changed to a second function for timing correction. In particular, the second function is configured to correct reverse link timing during a time period of either during or for a predetermined period after a handoff of the device from the first sector to the second sector, where the second function is based on a criterion different from criteria of the first function.

### BACKGROUND

1. Field

The present disclosure generally relates to methods and apparatus for reverse link timing correction in a communication system, and more specifically to reverse link timing correction.

2. Background

In broadband wireless communication systems, such as Ultra Mobile Broadband (UMB) for example, the transmit (Tx) timing of an access terminal (AT) or other mobile device for reverse link (RL) communication from the AT to a base station or access point (AP) is linked or mapped to the receiver (Rx) timing of the forward link (FL) with some predetermined mapping function (also termed herein as the “steady-state” function as this is the function normally used). This mapping or linking is done to automatically correct Tx timing based on an assumption that timing differences are mainly due to drift or offset from the clock or oscillator of a serving AP. An additional RL Tx timing offset may be applied due to other criteria, such as propagation delays, the timing offset being effected via commands from the serving AP. Thus, in such cases the aggregate RL Tx time is the sum of two applied corrections: one correction that follows the FL Rx timing, and one correction that follows AP commands such as SLP commands.

In an event where an AT communicates to two or more APs or base stations, such as in the case of a handoff event from a currently serving AP or sector to a target AP or sector, the timing of a reverse link Tx of the AT will be divergent from the timing of the target AP or sector because the AT transmit timing is tied to the currently serving sector. When the target sector becomes the serving sector during and after handoff, the timing of the AT is then tied to this new sector or AP. The AT transmit (Tx) timing of the RL must then converge using signaling messages sent from the new serving sector or AP.

It is noted, however, that in certain cases, such as when handing off from one sector to another sector, it has been recognized by the present inventors that the RL Tx timing of an AT may be adjusted in the wrong direction. One reason why this may occur is because the timing corrections to the RL Tx that are required to correct for oscillator drift are opposite to the timing corrections required to correct for a genuine propagation time difference. The timing corrections to the RL Tx are based on either timing messages from the AP or FL timing corrections. At handoff, there may be a delay before the desired serving sector can transmit a RL timing correction message to the AT. During this time, the RL timing corrections are based on the FL timing corrections that are now locked to the desired (target) sector. Typically, the RL Tx timing corrections are made based on the measured FL Rx corrections with the assumption that the corrections were necessary to correct for oscillator drift. During handoff, however, these timing changes are usually due to propagation time difference between the old serving sector and the new target sector thus resulting in an adjustment of RL Tx timing that is opposite to convergence or away from a target timing. A further complication may result if the AT is at the very edge of acceptable time offset (such as in the case of a run length constrained channel (RLCC)) between a currently serving sector and the target sector. This could cause the RL Tx timing of the AT to become unstable should the signaling messages from the target AP not have enough time in the RLCC window to prevent the AT Tx timing from going out of range as the FL timing converges. Accordingly, methods and apparatus that correct the RL Tx timing to prevent such instability would be beneficial.

### SUMMARY

According to an aspect, a method for reverse link timing correction in a wireless communication device is disclosed. The method includes first detecting a hand off of the device from a first sector currently serving the device to a second sector not currently serving the device. After the detection, the method further includes changing a first function linking timing correction of a reverse link of the device to forward link timing corrections to a second function configured to correct reverse link timing during a time period of at least one of during and for a predetermined period after a hand off of the device from the first sector to the second sector, where the second function is based on at least one criterion different from criteria of the first function.

According to another aspect, an apparatus operable in a wireless communication device for timing correction is disclosed. The apparatus features at least one processor configured to detect a hand off of the device from a first sector currently serving the device to a second sector not currently serving the device. The processor is also configured to change a first function linking timing correction of a reverse link of the device to forward link timing corrections to a second function configured to correct reverse link timing during a time period of at least one of during and for a predetermined period after a hand off of the device from the first sector to the second sector, where the second function is based on at least one criterion different from criteria of the first function. The apparatus also includes a memory coupled to the processor.

In a further aspect, an apparatus for timing correction in a wireless communication device is disclosed. The apparatus includes means for detecting a hand off of the device from a first sector currently serving the device to a second sector not currently serving the device. The apparatus further includes means for changing a first function linking timing correction of a reverse link of the device to forward link timing corrections to a second function configured to correct reverse link timing during a time period of at least one of during and for a predetermined period after a hand off of the device from the first sector to the second sector, where the second function is based on at least one criterion different from criteria of the first function.

In still one further aspect, a computer program product comprising computer readable medium is disclosed. The computer-readable medium includes code for causing a computer to detect a hand off of the device from a first sector currently serving the device to a second sector not currently serving the device. The computer-readable medium also includes code for causing a computer to change a first function linking timing correction of a reverse link of the device to forward link timing corrections to a second function configured to correct reverse link timing during a time period of at least one of during and for a predetermined period after a hand off of the device from the first sector to the second sector, where the second function is based on at least one criterion different from criteria of the first function.

### BRIEF DESCRIPTION OF THE DRAWINGS

FIG. 1 is a diagram of a communication system having at least two sectors or access points and an access terminal in range of both access points.

FIG. 2 is a flowchart of an exemplary method for adjusting reverse link timing in accordance with the present disclosure.

FIG. 3 is a block diagram of an exemplary access terminal for performing reverse link timing correction in accordance with the present disclosure.

FIG. 4 is a block diagram of another exemplary apparatus for performing reverse link timing correction in accordance with the present disclosure.

### DETAILED DESCRIPTION

The presently disclosed methods and apparatus provide reverse link timing correction in a wireless communication device to avoid potential timing instability of RL Tx timing during handoff. The correction or adjusting of RL transmit timing includes changing the mapping function linking timing correction of a reverse link of the device to forward link timing corrections (i.e., the “steady state” function). The mapping function is changed to a second function configured to correct reverse link timing during a time period during and/or for a predetermined period after a hand off of the device from a first sector currently serving a device to the second, target sector, where the second function is based on at least one criterion different from the criteria of the first function. Thus, by changing the mapping function during events where timing correction may lead to divergent RL timing, such as handoff as recognized by the present inventors, the timing correction may be modified to ensure convergence of RL timing.

In the following described examples, for reasons of conciseness and clarity the disclosure uses some terminology associated with Ultra Mobile Broadband (UMB) technology. It should be emphasized, however, that the presently described examples are also applicable to other technologies, such as technologies related to Code Division Multiple Access (CDMA), Time Division Multiple Access (TDMA), Frequency Division Multiple Access (FDMA), Orthogonal Frequency Division Multiple Access (OFDMA) and so forth. It will be appreciated by those skilled in the art, that when applying the disclosed methods and apparatus to other technologies, the associated terminology would clearly be different. As examples, an access point (AP) may be a fixed station used for communicating with the terminals and may also be referred to as an access point, a Node B, base station, or some other terminology. An access terminal (AT) may also be called an access terminal (AT), user equipment (UE), a wireless communication device, terminal, access terminal or some other terminology.

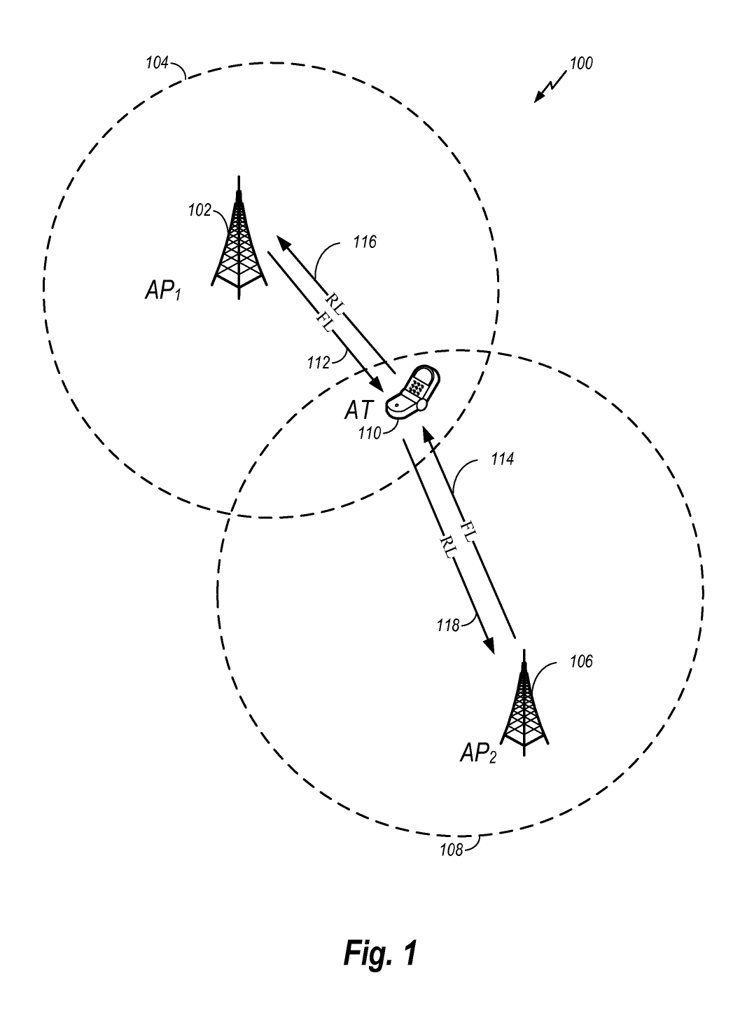

FIG. 1 illustrates a communication system 100 in which the present methods and apparatus may be utilized. The system 100 includes a first base station or access point (AP₁) 102 that may be associated with a first sector 104. System 100 also may include another base station or access point (AP₂) 106 associated with another sector 108 distinct from first sector 104.

An access terminal (AT) 110 within system 100 is assumed in communication range with both AP 102 and AP 106, where information is transmitted from the access points 102, 106 over respective forward links (FL) 112 and 114 to AT 110. Additionally, the APs 102 and 106 may receive information from access terminal 110 over reverse links (RL) 116 and 118, respectively.

Typically, one sector will serve network content to AT 110. In the example of FIG. 1, it is assumed for discussion purposes that sector 104 (e.g., AP 102) is currently the serving sector to AT 110. Nonetheless, AT 110 may also sense or receive information from another sector in range (i.e., sector 108 or AP 106), such as Sector identification information or other pilot signal information over the FL (e.g., FL 114).

As discussed previously, there may arise instances, such as when an AT is handing off from one sector to another (e.g., sector 104 to sector 108), where the timing of the RL transmit (Tx) timing of the AT may become unstable due in part to the RL Tx timing mapping function (i.e., the steady state function) causing timing to be adjusted in a direction opposite from what it should be. In order to correct or adjust the RL Tx timing, apparatus and methods are disclosed herein that adjust the RL Tx timing based on a different function from the steady state case, as well as a function of a further measurement of the time offset between the forward links of two sectors or APs. For example, in the system 100 of FIG. 1, the AT 110 may be configured to measure the time offset between an FL 112 of a currently serving sector 104 and an FL 114 of a target sector 108. According to a particular example, AT 110 may make changes to mapping function that is not based on the criterion of accounting for oscillator drift, but a distinct criterion, such as propagation time differential between the second target sector and the first currently serving sector that is present during a handoff, for example. Furthermore, RL timing correction may be further enhanced by basing timing corrections on a measurement of the time offset between FL pilots from two sectors with which an AT is communicating (e.g., sectors 104 and 108) to determine the relative time offset between the two sectors.

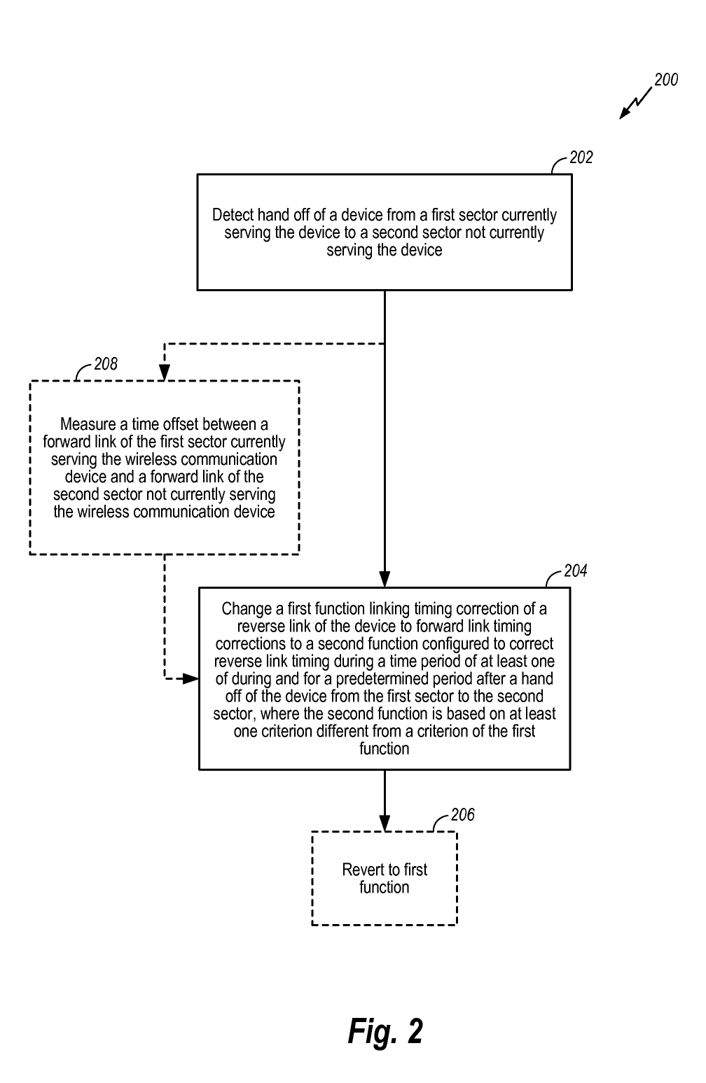

FIG. 2 provides an exemplary flow chart of a method 200 for adjusting or correcting the RL Tx timing by changing the mapping function mapping FL timing to RL timing. Method 200 includes a block 202 where a hand off a wireless communication device (i.e., an AT) from a first sector currently serving the device to a second sector not currently serving the device is detected or determined. For example, the process of block 202 may be effected by an AT, such as AT 110 in FIG. 1. It is further noted that hand off of the device from one sector to another may be initiated by the AT, one or more APs, such as AP 104, or a combination of the AT and one or more APs.

After determining that a hand off event is occurring in block 202, flow proceeds to block 204 where a first function linking timing correction of a reverse link of the device to forward link timing corrections is then changed to a second function configured to correct reverse link timing during a time period of at least one of during and for a predetermined period after a hand off of the device from the first sector to the second sector, where the second function is based on at least one criterion different from criteria of the first function.

In an aspect, the first function in the process of block 204 may be a steady state function or other function normally used for timing correction of the RL based on a mapping to the FL based on criteria or assumptions that timing corrections will be due to oscillator drift of the AT oscillator. Thus, the second function is based on a criterion or concern different from these concerns and may be configured according to any number of criteria for achieving a desired RL Tx timing adjustment or correction.

In a first example, the different criteria of the second function are an assumption that timing corrections during a handoff event will be due to a propagation time differential between the target sector (e.g., the second sector) and the currently serving sector (e.g., the first sector). Accordingly, the first function may be changed or altered to a second function for a temporary period during or after handoff to ensure that RL timing correction does not diverge from a target timing by timing correction based on the assumption that timing corrections will be needed due to propagation time differences, and not due to oscillator drift. It is noted that although FIG. 2 also illustrates that, subsequent to block 204, the method 200 may include reversion of timing correction of the RL back to the first function as illustrated by optional block 206. It is noted that reversion to the first function may occur upon return to a steady state after handoff or after the predetermined time period after handoff.

Moreover, as it has been recognized that timing correction using the first function may lead to correction in a direction opposite to convergence of timing, in particular, it is noted that the second function may also be based on a criterion to correct timing in a direction opposite to the reverse timing corrections performed by the first function. According to an example, the second function may be either a linear or a non-linear function linked to forward link timing corrections that is configured to cause timing corrections of the reverse link to be opposite to the reverse link timing corrections performed by the first function. In a simple example, the second function could be the negative value of the RL timing correction performed by the first function.

According to still a further aspect, the second function of block 204 may be one of a linear and a non-linear function based on a criterion of a determined signal propagation time difference between forward link signals from the first sector and signals from the second sector to correct timing of the reverse link. Accordingly, for this alternative, method 200 also shows block 208 where the determination of the signal propagation time difference includes measuring a measuring a time offset between a forward link of the first sector currently serving the wireless communication device (AT) and a forward link of the second sector not currently serving the wireless communication. It is noted that in an aspect, the measured forward link transmissions may occur prior to, during, or for a predetermined period after a handoff event of the AT from the first sector to the second sector.

It is noted that although block 208 is illustrated as a sequential process occurring prior to the process of block 204, the processes of blocks 204 and 208 may be performed concomitantly, and may be executed independently or in dependence of each other. It is noted that the measured forward link information may be obtained from FL pilot symbols, or any other suitable information transmitted over the FL or RL that may be usable to determine FL timing. From this timing information of the first and second sectors, the measure of the relative time offset between the FL timing of the two sectors may be calculated or estimated according any one of a number of known techniques or methods.

As another example, the second function may be configured to adjust the timing of a reverse link transmitter by a negative or opposite value of the measured time offset. For example, if the time offset is equal to a value T, then the adjustment function would adjust by a value of −T. As further example, the function may be configured to adjust the timing of the reverse link transmitter by a fixed multiple of T, such as two times a negative value of the time offset (e.g., −2T). Furthermore, other exemplary functions of the time offset may be configured to cause the RL Tx timing to be adjusted by a negative linear or non-linear function of the time offset, where the non-linear function could be an increasing or decreasing function.

The FL link timing corrections, which were discussed previously, serve to lock the timing of an oscillator in the wireless communication to a serving sector to account for oscillator drift. Additionally, the function of the FL link timing corrections may be configured to cause the timing to be adjusted in the opposite or negative direction. As yet a further alternative, the processes of block 206 may be performed at least one of during and for a predetermined period after a handoff of the wireless communication device from the first base station to the second base station.

According to another aspect, the method 200 may also allow reduction of a timing window at the at least a second sector during a handoff event of the wireless communication device from the first sector to the at least a second sector. Typically, an AP controls the RL timing of an AT that is served by it by transmitting timing correction messages on the forward link to adjust reverse link timing. These messages are generated by estimating the RL timing of the AT and then comparing with respect to a target set-point. The estimation typically requires a search for the RL timing over a pre-defined duration, that we term here as “search window”. The inventors recognize that if RL timing during handoff is not properly adjusted, the timing of the RL transmissions may drift away from the target set-point. To ensure that the AP can still detect the RL timing a larger search window would to be defined to take into account possible timing slew. However, if the RL transmissions are corrected as described in this invention, then a smaller search window can suffice at the second sector. This reduces the search complexity for RL time correction at the AP.

It is noted, that the presently disclosed methods (and apparatus) are not only applicable to handoff events, and it is contemplated that adjustment of the RL timing effected by method 200 is applicable to any event where the AT transmits on the RL to any non-serving sector (e.g., the second sector) giving rise to propagation time difference effects on timing correction. It is also noted that the second function may still map the FL timing to the RL timing as with the first function, but that the second function is not established or based upon the assumption that timing corrections are to account for oscillator drift, but rather is based on timing correction due to propagation time difference between a target and a serving sector.

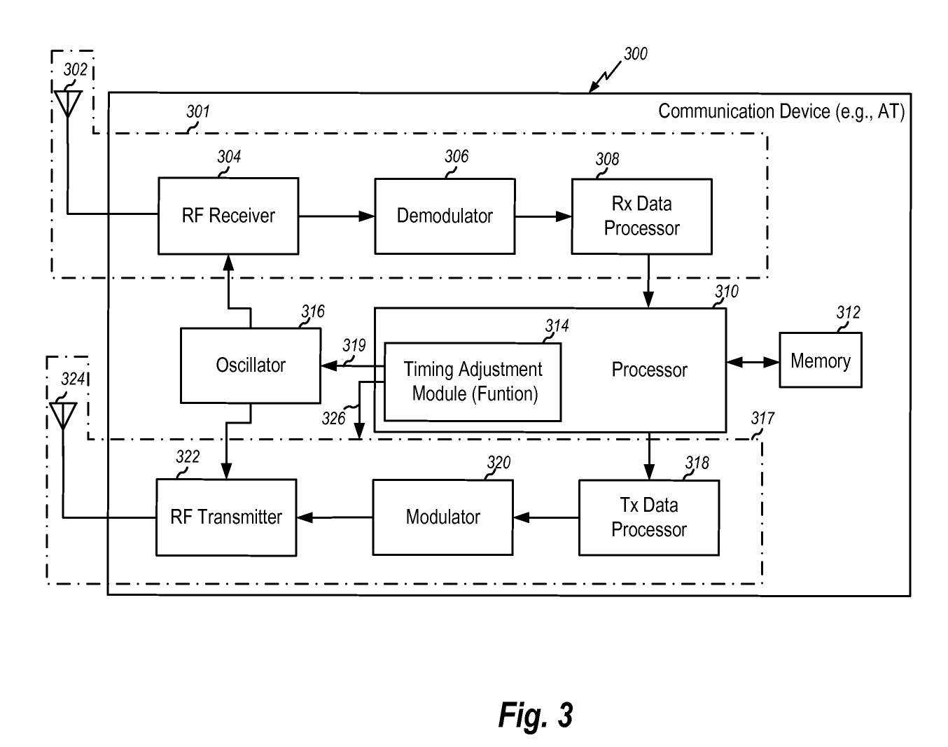

FIG. 3 illustrates a block diagram of an exemplary wireless communication device, such as an AP, that utilizes timing adjustment of the RL Tx timing. The apparatus 300 includes a forward link (FL) receive portion 301 of device 300 that includes one or more receive antennae 302, an RF receiver 304, a demodulator 306, and a receive data processor 308. Data demodulated and decoded over the FL portion 301 is then sent to a processor 310, which may be a digital signal processor (DSP), general purpose processor (GPP), or any other suitable processor or computer. The processor 310 is coupled with a memory device 312 (either external as shown or integral to processor 310) that stores instructions or code executable by the processor 310.

As illustrated, the processor 310 may execute some or all of timing correction or adjustment disclosed in the methodology discussed above in connection with FIG. 2. Accordingly, processor 310 is illustrated with a representative functional module 314 for timing adjustment in accordance with the present disclosure. The timing adjustment performed by processor 310 as represented visually by module 314 includes determining FL timing information derived from the FL receive portion 301 from a currently serving sector, as well as from other non-serving sectors. This FL timing information may be used to determine the time offset, such as was described earlier in connection with the processes of block 208 in FIG. 2.

Device 300 also includes an oscillator or clock 316 for use in timing of the FL receive portion 301, as well as a reverse link (RL) transmit (Tx) portion 317. The oscillator 316 may be communicatively coupled to processor 310 as illustrated by link 319 for adjustments to oscillator timing, such as to correct for drift from a clock of a currently serving sector. More typically, however, timing corrections are made by adjusting RL baseband transmission in the RL Tx portion 317, as will be discussed more fully below.

The RL Tx portion 317 may include a Transmit Data processor 318, which receives data to be transmitted over the RL from processor 310, a modulator 320, an RF transmitter 322, and one or more transmit antennae 324. The processor 310 provides timing adjustment control of the RL Tx portion 317, as representatively illustrated by communication coupling 326. As discussed previously in connection with the method of FIG. 2, timing adjustment is based on a function different from a normal time correction function mapping the RL timing to FL timing correction, which is determined by module 314 (i.e., processor 310). Thus, in an example the processes of blocks 202 and 204 (as well further measurement of FL timing offset between a serving and target sector as shown by block 208) in FIG. 2 are implemented by processor 310. In an aspect, the RL Tx timing of portion 317 may be typically effected by the processor 310 directly to RL Tx baseband chips (not shown) within the RL Tx portion 317. Thus, timing corrections are normally effected through baseband corrections in the RL Tx portion 317. Alternatively, the processor may effect timing adjustment via the oscillator 316 as mentioned above.

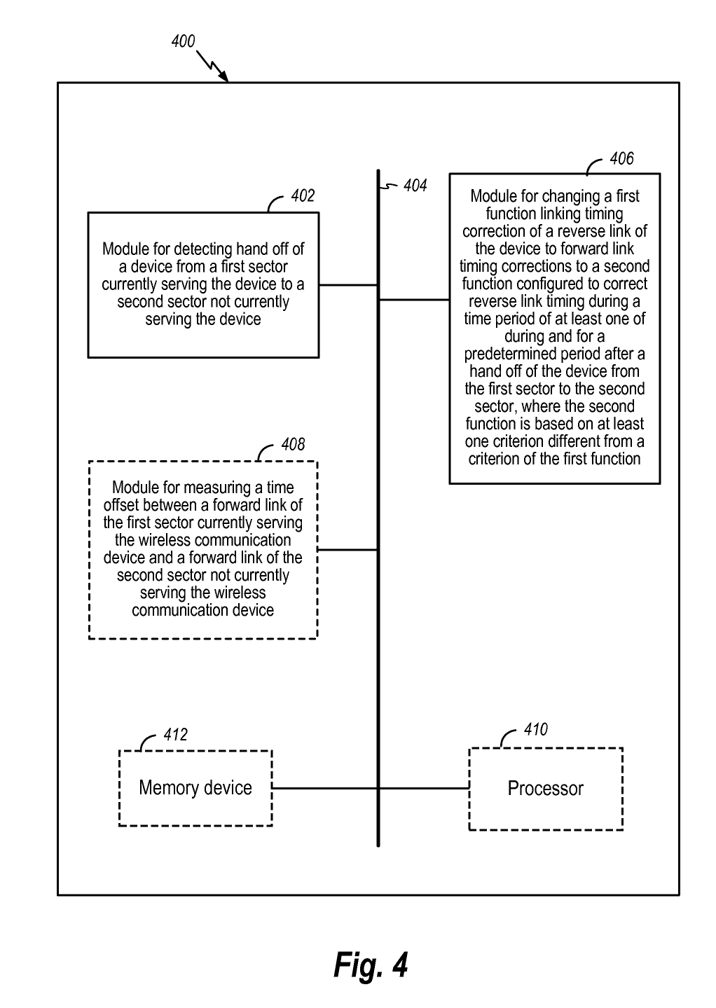

FIG. 4 illustrates a block diagram of another exemplary apparatus 400 for performing reverse link timing correction in accordance with the present disclosure. The apparatus 400, which may be implemented in a wireless communication device such as an access terminal (AT), includes a module 402 for detecting hand off of a device from a first sector currently serving the device to a second sector not currently serving the device. It is noted that module 402 may effect the processes discussed previously with respect to block 202 in FIG. 2. The information determined by module 402 may then be communicated to various other modules in apparatus 400 via a bus 404, or similar suitable communication coupling.

Apparatus 400 further includes a module 406 or changing a first function linking timing correction of a reverse link of the device to forward link timing corrections to a second function configured to correct reverse link timing during a time period of at least one of during and for a predetermined period after a hand off of the device from the first sector to the second sector, where the second function is based on at least one criterion different from a criterion of the first function. The second function may be configured according to any one or more of criterion contemplated herein in the discussion concerning block 204 in FIG. 2.

According to an aspect, apparatus 400 may include an optional module 408 (shown dashed accordingly) measuring a time offset between a forward link of the first sector currently serving the wireless communication device and a forward link of the second sector not currently serving the wireless communication device. Also, the apparatus 400 may include an optional computer readable medium or memory device 412 configured to store computer readable instructions and data for effecting the processes and behavior of either the modules. Additionally, apparatus 400 may include a processor 410 to execute the computer readable instructions in memory 412, and may be configured to execute one or more functions of the various modules in apparatus 400.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those skilled in the art will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, means, and steps have been described above generally in terms of their functionality. Whether such functionality is implemented as hardware or software depends upon the particular application and design constraints imposed on the overall system. Those skilled in the art may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium (not shown) may be coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The examples described above are merely exemplary and those skilled in the art may now make numerous uses of, and departures from, the above-described examples without departing from the inventive concepts disclosed herein. Various modifications to these examples may be readily apparent to those skilled in the art, and the generic principles defined herein may be applied to other examples, e.g., in an instant messaging service or any general wireless data communication applications, without departing from the spirit or scope of the novel aspects described herein. Thus, the scope of the disclosure is not intended to be limited to the examples shown herein but is to be accorded the widest scope consistent with the principles and novel features disclosed herein. It is noted that the word “exemplary” is used exclusively herein to mean “serving as an example, instance, or illustration.” Any example described herein as “exemplary” is not necessarily to be construed as preferred or advantageous over other examples. Accordingly, the novel aspects described herein are to be defined solely by the scope of the following claims.

What is claimed is:

1. A method for reverse link timing correction in a wireless communication device, the method comprising:
detecting a hand off of the device from a first sector currently serving the device to a second sector not currently serving the device; and
changing a first function linking timing correction of a reverse link of the device to forward link timing corrections to a second function configured to correct reverse link timing during a time period of at least one of during and for a predetermined period after a hand off of the device from the first sector to the second sector, where the second function is based on at least one criterion different from criteria of the first function.

2. The method as defined in claim 1, wherein the criterion of the first function is performing timing correction to correct for drift of an oscillator in the wireless communication device.

3. The method as defined in claim 1, wherein the at least one criterion of the second function is performing timing correction to correct for a propagation time difference between signals from the first sector and signals from the second sector.

4. The method as defined in claim 3, wherein the second function is one of a linear and a non-linear function linked to forward link timing corrections that is configured to cause timing corrections of the reverse link to be opposite to the reverse link timing corrections performed by the first function.

5. The method as defined in claim 3, wherein the second function is one of a linear and or a non-linear function based on determining the signal propagation time difference between forward link signals from the first sector and forward link signals from the second sector to correct timing of the reverse link.

6. The method as defined in claim 5, wherein determining the signal propagation time difference further comprises:
measuring a time offset between a forward link of the first sector currently serving the wireless communication device and a forward link of the second sector not currently serving the wireless communication device.

7. The method as defined in claim 1, further comprising:
reducing a timing window at the second sector during a handoff event of the wireless communication device from the first sector to the at least a second sector.

8. The method as defined in claim 1, wherein the second function is one of a linear and a non-linear function based on a signal propagation time difference between signals from the first sector and signals from the second sector and forward link timing corrections during a handoff event, wherein the second function is operable to cause timing corrections of the reverse link to be opposite to the reverse link timing corrections performed by the first function.

9. An apparatus operable in a wireless communication device for timing correction, the apparatus comprising:
at least one processor configured to:
detect a hand off of the device from a first sector currently serving the device to a second sector not currently serving the device; and
change a first function linking timing correction of a reverse link of the device to forward link timing corrections to a second function configured to correct reverse link timing during a time period of at least one of during and for a predetermined period after a hand off of the device from the first sector to the second sector, where the second function is based on at least one criterion different from criteria of the first function; and
a memory coupled to the processor.

10. The apparatus as defined in claim 9, wherein the criterion of the first function is performing timing correction to correct for drift of an oscillator in the wireless communication device.

11. The apparatus as defined in claim 9, wherein the at least one criterion of the second function is performing timing correction to correct for a propagation time difference between signals from the first sector and signals from the second sector.

12. The apparatus as defined in claim 11, wherein the second function is one of a linear and a non-linear function linked to forward link timing corrections that is configured to cause timing corrections of the reverse link to be opposite to the reverse link timing corrections performed by the first function.

13. The apparatus as defined in claim 11, wherein the second function is one of a linear and a non-linear function based on determining the signal propagation time difference between forward link signals from the first sector and forward link signals from the second sector to correct timing of the reverse link.

14. The apparatus as defined in claim 13, wherein the at least one processor is configured to determine the signal propagation time difference by measuring a time offset between a forward link of the first sector currently serving the wireless communication device and a forward link of the second sector not currently serving the wireless communication device.

15. The apparatus as defined in claim 9, further comprising:
wherein the at least one processor is configured to initiate a reduction in a timing window at the second sector during a handoff event of the wireless communication device from the first sector to the at least a second sector.

16. The apparatus as defined in claim 9, wherein the second function is one of a linear and a non-linear function based on a signal propagation time difference between signals from the first sector and signals from the second sector and forward link timing corrections during a handoff event, wherein the second function is operable to cause timing corrections of the reverse link to be opposite to the reverse link timing corrections performed by the first function.

17. An apparatus for timing correction in a wireless communication device comprising:
means for detecting a hand off of the device from a first sector currently serving the device to a second sector not currently serving the device; and
means for changing a first function linking timing correction of a reverse link of the device to forward link timing corrections to a second function configured to correct reverse link timing during a time period of at least one of during and for a predetermined period after a hand off of the device from the first sector to the second sector, where the second function is based on at least one criterion different from criteria of the first function.

18. The apparatus as defined in claim 17, wherein the criterion of the first function is performing timing correction to correct for drift of an oscillator in the wireless communication device.

19. The apparatus as defined in claim 17, wherein the at least one criterion of the second function is performing timing correction to correct for a propagation time difference between signals from the first sector and signals from the second sector.

20. The apparatus as defined in claim 19, wherein the second function is one of a linear and a non-linear function linked to forward link timing corrections that is configured to cause timing corrections of the reverse link to be opposite to the reverse link timing corrections performed by the first function.

21. The apparatus as defined in claim 19, wherein the second function is one of a linear and a non-linear function based on determining the signal propagation time difference between forward link signals from the first sector and forward link signals from the second sector to correct timing of the reverse link.

22. The apparatus as defined in claim 21, wherein determining the signal propagation time difference is determined by means for measuring a time offset between a forward link of the first sector currently serving the wireless communication device and a forward link of the second sector not currently serving the wireless communication device.

23. The apparatus as defined in claim 17, further comprising:
reducing a timing window at the second sector during a handoff event of the wireless communication device from the first sector to the at least a second sector.

24. The apparatus as defined in claim 17, wherein the second function is one of a linear and a non-linear function based on a signal propagation time difference between signals from the first sector and signals from the second sector and forward link timing corrections during a handoff event, wherein the second function is operable to cause timing corrections of the reverse link to be opposite to the reverse link timing corrections performed by the first function.

25. A computer program product, comprising:
computer-readable medium comprising:
code for causing a computer to detect a hand off of the device from a first sector currently serving the device to a second sector not currently serving the device; and
code for causing a computer to change a first function linking timing correction of a reverse link of the device to forward link timing corrections to a second function configured to correct reverse link timing during a time period of at least one of during and for a predetermined period after a hand off of the device from the first sector to the second sector, where the second function is based on at least one criterion different from criteria of the first function.

26. The computer program product as defined in claim 25, wherein the criterion of the first function is performing timing correction to correct for drift of an oscillator in the wireless communication device.

27. The computer program product as defined in claim 25, wherein the at least one criterion of the second function is performing timing correction to correct for a propagation time difference between signals from the first sector and signals from the second sector.

28. The computer program product as defined in claim 27, wherein the second function is one of a linear and a non-linear function linked to forward link timing corrections that is configured to cause timing corrections of the reverse link to be opposite to the reverse link timing corrections performed by the first function.

29. The computer program product as defined in claim 27, wherein the second function is one of a linear and a non-linear function based on determining the signal propagation time difference between forward link signals from the first sector and forward link signals from the second sector to correct timing of the reverse link.

30. The computer program product as defined in claim 29, wherein determining the signal propagation time difference is determined using code for causing a computer to measure a time offset between a forward link of the first sector currently serving the wireless communication device and a forward link of the second sector not currently serving the wireless communication device.

31. The computer program product as defined in claim 25, further comprising:
code for causing the computer to initiate a reduction in a timing window at the second sector during a handoff event of the wireless communication device from the first sector to the at least a second sector.

32. The computer program product as defined in claim 25, wherein the second function is one of a linear and a non-linear function based on a signal propagation time difference between signals from the first sector and signals from the second sector and forward link timing corrections during a handoff event, wherein the second function is operable to cause timing corrections of the reverse link to be opposite to the reverse link timing corrections performed by the first function.
